(19) United States
(12) Patent Application Publication
(10) Pub. No.: US 2026/0318699 A1
(43) Pub. Date: Oct. 15, 2026

(54) INFORMATION PROCESSING APPARATUS, VEHICLE, ROUTE DETERMINATION METHOD, AND STORAGE MEDIUM

(71) Applicant: Mitsubishi Electric Corporation, Tokyo (JP)

(72) Inventors: Miki ARAI, Tokyo (JP); Dongsuk PARK, Tokyo (JP); Takayasu HASHIMOTO, Tokyo (JP); Yuri KUBOTA, Tokyo (JP); Misato WATANABE, Tokyo (JP)

(73) Assignee: Mitsubishi Electric Corporation, Tokyo (JP)

(21) Appl. No.: 19/464,623

(22) Filed: Jan. 30, 2026

Related U.S. Application Data
(63) Continuation of application No. PCT/JP2023/029144, filed on Aug. 9, 2023.

(51) Int. Cl. G01C 21/36

(52) U.S. Cl. CPC G01C 21/3617

(57) ABSTRACT

An information processing unit according to the present disclosure is an information processing unit that determines a route for a vehicle to travel. The information processing unit includes: an information acquisition unit that acquires position-related information that is information related to a position of a second user different from a first user who rides in the vehicle; a destination setting unit that sets a destination of the vehicle, using the position-related information; and a route search unit that determines a route for the vehicle to travel from a riding location where the first user rides in the vehicle to the destination set by the destination setting unit.

### CROSS-REFERENCE TO RELATED APPLICATION

This application is a continuation application of International Application PCT/JP2023/029144, filed on Aug. 9, 2023, and designating the U.S., the entire contents of which are incorporated herein by reference.

### BACKGROUND OF THE INVENTION

### 1. Field of the Invention

The present disclosure relates to an information processing apparatus, a vehicle, a route determination method, and a storage medium, which are used for searching for a route for a vehicle to travel.

### 2. Description of the Related Art

A technique for searching for a vehicle route to a destination is known. Japanese Patent No. 5872229 discloses a technique for allowing a user who rides in a vehicle to designate a destination and for searching for a vehicle route to the designated destination.

According to the technique disclosed in Japanese Patent No. 5872229, a destination is input by a user who rides in a vehicle. However, in a case where only a child or only an elderly person rides in a vehicle, for example, in an automated driving vehicle, it may be difficult for the user to appropriately input a destination.

The present disclosure has been made in view of the above circumstances, and an object of the present disclosure is to provide an information processing apparatus capable of determining a route for a vehicle to travel without requiring input of a destination by a user who rides in the vehicle.

### SUMMARY OF THE INVENTION

To solve the above problem and achieve the object, the present disclosure provides an information processing apparatus to determine a route for a vehicle to travel, the information processing apparatus comprising: an information acquisition unit to acquire position-related information that is information related to a position of a second user different from a first user who rides in the vehicle; a destination setting unit to set a destination of the vehicle, using the position-related information; and a route search unit to determine a route for the vehicle to travel from a riding location where the first user rides in the vehicle to the destination set by the destination setting unit.

### BRIEF DESCRIPTION OF THE DRAWINGS

FIG. 1 is a diagram illustrating an exemplary configuration of a vehicle according to a first embodiment;

FIG. 2 is a flowchart illustrating an example of route determination processing for an information processing unit according to the first embodiment;

FIG. 3 is an image diagram illustrating a specific example of a route determination method according to the first embodiment;

FIG. 4 is a diagram illustrating an example of a route determination system according to the first embodiment;

FIG. 5 is a diagram illustrating an exemplary configuration of a manual driving vehicle according to the first embodiment;

FIG. 6 is a diagram illustrating an exemplary configuration of a computer system that implements the information processing unit and an information processing apparatus according to the first embodiment;

FIG. 7 is a diagram illustrating an exemplary configuration of a vehicle according to a second embodiment;

FIG. 8 is a flowchart illustrating an example of route determination processing for an information processing unit according to the second embodiment;

FIG. 9 is a diagram illustrating an exemplary configuration of a vehicle according to a third embodiment; and

FIG. 10 is a flowchart illustrating an example of route determination processing for an information processing unit according to the third embodiment.

### DETAILED DESCRIPTION OF THE PREFERRED EMBODIMENTS

Hereinafter, an information processing apparatus, a vehicle, a route determination method, and a storage medium according to embodiments will be described in detail with reference to the drawings.

### First Embodiment

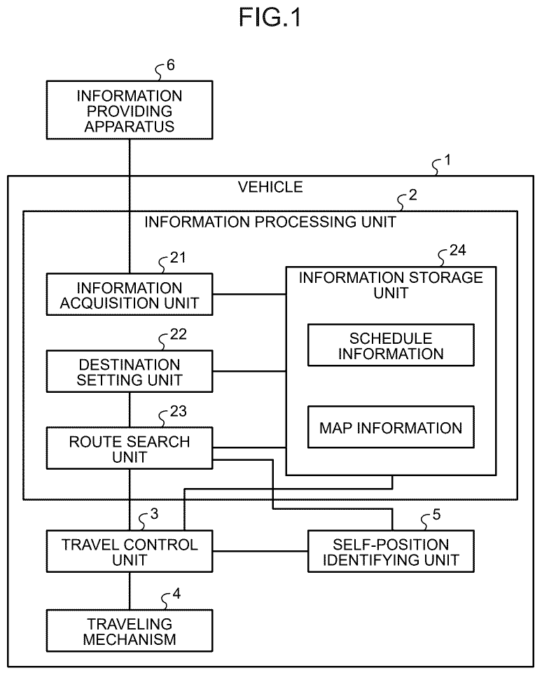

FIG. 1 is a diagram illustrating an exemplary configuration of a vehicle according to a first embodiment. A vehicle 1 according to the present embodiment includes an information processing unit 2, a travel control unit 3, a traveling mechanism 4, and a self-position identifying unit 5. The vehicle 1 is capable of carrying a user who uses the vehicle 1 and transporting the user to a destination. In an example illustrated in FIG. 1, the vehicle 1 is an automated driving vehicle capable of performing automated driving. However, as will be described later, the present embodiment is not limited to the automated driving vehicle and is also applicable to a manual driving vehicle driven by a driver. Additionally, the present embodiment is also applicable to a vehicle capable of switching between automated driving and manual driving.

The information processing unit 2 is an example of an information processing apparatus for determining a route of the vehicle 1 (a route for the vehicle 1 to travel). The information processing unit 2 includes an information acquisition unit 21, a destination setting unit 22, a route search unit 23, and an information storage unit 24.

The information acquisition unit 21 receives information by communicating with another apparatus. For example, the information acquisition unit 21 acquires schedule information by receiving, from an information providing apparatus 6, schedule information indicating a schedule of a second user different from a first user being a user who rides in a vehicle, and stores the acquired schedule information in the information storage unit 24. The schedule information on the second user is an example of position-related information that is information related to the position of the second user. For example, the first user is a child, and the second user is a guardian such as a parent of the child who is the first user. The child may be a minor, may be a child of elementary school age or younger, or may be an infant. Alternatively, the first user may be an elderly person, and the second user may be a spouse, a child, a relative, or the like of the elderly person who is the first user. The relationship between the first user and the second user is not limited thereto, and it is sufficient that the second user corresponding to the first user is predetermined. The second user is, for example, a person who meets the first user transported by the vehicle 1, and thus can be said to be a user who indirectly uses the vehicle 1.

For example, in a case where the vehicle 1 is dispatched in accordance with reservation, identification information on the second user corresponding to the first user is registered, at the time of the reservation, in a vehicle dispatch management apparatus (not illustrated) that manages dispatch of the vehicle 1, and when the vehicle dispatch management apparatus provides a dispatch instruction to the vehicle 1, the identification information on the second user is transmitted to the vehicle 1. The information acquisition unit 21 acquires the identification information on the second user by receiving the identification information on the second user from the vehicle dispatch management apparatus, and acquires the schedule information from the information providing apparatus 6 based on the acquired identification information on the second user. The identification information, that is, user identification information may be a login IDentifier (ID) provided in order to use a mobility service involving the vehicle 1. Alternatively, the identification information is not limited to the login ID for using the mobility service involving the vehicle 1 and may also be a login ID provided in order to use a general-purpose service, a login ID for using a schedule management service for managing schedule information, or the like, may be identification information on a user terminal that is a terminal apparatus operable by the user, or may be other information.

In a case where the login ID for using the mobility service involving the vehicle 1 is used as the user identification information, the schedule information on the user may also be managed within a service system that provides the mobility service. For example, the user logs in, using the login ID for using the mobility service, to a mobility provision service system that provides the mobility service, and registers schedule information. In this case, the schedule information may be stored in the vehicle dispatch management apparatus, may be stored in an information processing apparatus different from the vehicle dispatch management apparatus within the mobility provision service system that provides the mobility service, or may be stored in the user terminal. Furthermore, in connection with the user's use of the mobility provision service system, reference to the schedule information stored in a predetermined format in the user terminal is permitted, and the information acquisition unit 21 may acquire the schedule information from, for example, the user terminal having been used by the user to log in to the system for the vehicle 1. The information acquisition unit 21 acquires the schedule information from the apparatus in which the schedule information is stored. The information providing apparatus 6 may be the vehicle dispatch management apparatus, may be an information processing apparatus different from the vehicle dispatch management apparatus, or may be the user terminal. Note that the information acquisition unit 21 may acquire the schedule information via another apparatus from the information providing apparatus 6 in which the schedule information is stored. For example, the vehicle dispatch management apparatus may acquire schedule information from the user terminal, and the information acquisition unit 21 may acquire the schedule information from the vehicle dispatch management apparatus.

Note that the user may be able to use the mobility provision service system by installing, on the user terminal, application software (hereinafter, also referred to as an application) for using the mobility provision service system, or by logging in to a web page for using the mobility provision service system

Even in a case where a general-purpose login ID, which is a login ID provided in order to use a general-purpose service, is used as the user identification information, the schedule information on the user may, as in the above example, be managed by the mobility provision service system that provides the mobility service. Alternatively, in the case where the general-purpose login ID is used as the user identification information, a schedule information management service system that provides a schedule management service for managing schedule information and the mobility provision service system may cooperate with each other, and the information acquisition unit 21 may acquire schedule information from a schedule information management apparatus that manages the schedule information in the schedule information management service system. That is, the information providing apparatus 6 may be the schedule information management apparatus.

In a case where a reservation management login ID, which is a login ID provided in order to use a reservation management service, is used as the user identification information, for example, in the case where the general-purpose login ID is used as the user identification information, the schedule information management service system that provides the schedule management service for managing schedule information and the mobility provision service system may cooperate with each other, and the information acquisition unit 21 may acquire schedule information from the schedule information management apparatus that manages the schedule information in the schedule information management service system. That is, the information providing apparatus 6 may be the schedule information management apparatus.

In a case where the identification information on the user terminal is used as the user identification information, the information acquisition unit 21 acquires schedule information from, for example, the user terminal.

Furthermore, the method of associating the first user with the second user is not limited to the above-described example. For example, when the first user rides in the vehicle 1, the first user may present presentation information. The presentation information is reservation identification information assigned to the reservation, user identification information on the first user, or user identification information on the second user. The presentation information is recorded on an IC card or indicated as, for example, a two-dimensional code such as a QR (registered trademark) code. When the first user rides in the vehicle 1, the first user causes a reader (not illustrated) for the vehicle 1 to read the IC card or the two-dimensional code. The information acquisition unit 21 receives the presentation information from the reader and acquires the schedule information from the information providing apparatus 6 based on the presentation information.

In a case where the presentation information is the reservation identification information, the information acquisition unit 21 may transmit the reservation identification information to the vehicle dispatch management apparatus and make an inquiry to the vehicle dispatch management apparatus, and thus acquire, from the vehicle dispatch management apparatus, the user identification information on the second user corresponding to the reservation identification information. For example, the reservation identification information is determined by the vehicle dispatch management apparatus at the time of reserving the vehicle 1. Alternatively, when receiving a dispatch instruction from the vehicle dispatch management apparatus, the information acquisition unit 21 may receive, from the vehicle dispatch management apparatus, the reservation identification information and the user identification information on the second user corresponding to the reservation identification information and store them. In this manner, the information acquisition unit 21 may grasp the user identification information on the second user corresponding to the presentation information received from the reader. Even in a case where the presentation information is the user identification information on the first user, as in the case where the presentation information is the reservation identification information, the information acquisition unit 21 may make an inquiry to the vehicle dispatch management apparatus, and thus acquire, from the vehicle dispatch management apparatus, the user identification information on the second user corresponding to the user identification information on the first user, or may receive, from the vehicle dispatch management apparatus, the user identification information on the first user and the user identification information on the second user corresponding to the user identification information on the first user and store them. Note that, in the case where the presentation information is the user identification information on the first user, the vehicle dispatch management apparatus also accepts registration of the user identification information on the first user together with the user identification information on the second user, for example, at the time of registration of use of the mobility service. The user identification information on the first user may be information used for biometric authentication.

Note that an acceptance unit (not illustrated) that accepts an input from the first user may accept input of the above-described presentation information. In this case, the presentation information is output from the acceptance unit to the information acquisition unit 21. The vehicle 1 may be compatible with both the reading of the presentation information by the above-described reader and the acceptance of the input of the presentation information by the acceptance unit, allowing the first user to select either one. Additionally, the acceptance unit may accept, from the first user, input of instruction information for instructing departure of the vehicle 1, that is, start of the vehicle 1, and output the instruction information to the route search unit 23.

Additionally, in a case where the vehicle 1 is not a vehicle dispatched in accordance with reservation, but is, for example, a private vehicle or the like, the identification information on the information providing apparatus 6 from which the schedule information is acquired may be registered in advance in the vehicle 1. For example, identification information on the user terminal of the second user may be registered as the information providing apparatus 6. Consequently, the information acquisition unit 21 acquires the schedule information from the second user's user terminal, which serves as the information providing apparatus 6.

The destination setting unit 22 sets a destination of the vehicle 1 using the schedule information on the second user. Specifically, the destination setting unit 22 determines a destination of the vehicle 1 using the schedule information stored in the information storage unit 24, sets the determined destination as the destination of the vehicle 1, and notifies the route search unit 23 of the set destination.

For example, the destination setting unit 22 calculates a distance between a departure location and a first location, which is a location corresponding to a first schedule, which is a schedule after a departure time and has the earliest time, among schedules indicated by the schedule information, calculates an estimated required time based on the distance, and selects the first schedule as a route search target when the second user is scheduled to be present at the first location at a time after elapse of the estimated required time from the departure time. When the second user is not scheduled to be present at the first location at the time after elapse of the estimated required time from the departure time, the destination setting unit 22 calculates a distance between the departure location and a second location, which is a location corresponding to a second schedule, which is a schedule after the departure time and has the second earliest time, calculates an estimated required time based on the distance, and selects the second schedule as the route search target when the second user is scheduled to be present at the second location at a time after elapse of the estimated required time from the departure time. When the second user is not at the second location at the time after elapse of the estimated required time from the departure time, the destination setting unit 22 similarly changes the schedule to be targeted to a next schedule, and repeats these processes until a schedule is found in which the second user is to be present at a location corresponding to the target schedule at a time after elapse of the estimated required time from the departure time, and selects the found schedule as the route search target. Then, the destination setting unit 22 determines, as the destination, a location corresponding to the schedule selected as the route search target.

The information storage unit 24 is capable of storing various types of information. For example, as illustrated in FIG. 1, the information storage unit 24 stores schedule information and map information. The map information is information indicating a map including information relating to roads, and includes a position of each road, the number of lanes of each road, a traveling direction of each lane, positions of traffic lights, regulation information indicating regulations such as one-way traffic and temporary stop, and the like. The map information may also include information indicating a curvature of a curve of a road, a gradient of a road, a degree of unevenness of a road surface of a road, and the like. The map information may also include information, such as a crime prevention map, indicating, for each block on a map, occurrence situations of crimes that occurred (types and frequencies of crimes that occurred) in the past. The map information may also include information indicating brightness for each block. The map information may also be information indicating a static map in high-precision three-dimensional map data, such as a dynamic map, including dynamic and quasi-dynamic information. Furthermore, when at least one of traffic signal information and traffic jam information is included in the dynamic map, such information may be acquired as the dynamic map.

The route search unit 23 determines, using the map information stored in the information storage unit 24, a route for the vehicle 1 to travel (a route of the vehicle 1) from a departure location (riding location) to a destination provided as a notification from the destination setting unit 22, and notifies the travel control unit 3 of the determined route. For example, the route search unit 23 determines, as the destination of the vehicle 1, a location corresponding to a schedule after a departure time and such that the vehicle 1 can arrive at the location while the second user is to be present at the location corresponding to the schedule, among the schedules indicated by the schedule information.

For example, the route search unit 23 searches for, based on the map information stored in the information storage unit 24, a route for arriving at the destination within a time period during which the second user is to be present at the destination, and when there is the route for arriving at the destination within the time period during which the second user is to be present at the destination, determines this route as the route of the vehicle 1. As a result of the route search, when there is no route for arriving at the destination within the time period during which the second user is to be present at the destination, the route search unit 23 changes the schedule to be selected as the route search target and performs similar processes. The route search unit 23 repeats these processes until the route for arriving at the destination in which the second user is to be present at the destination is found. By traveling on the route determined in this manner, the vehicle 1 can transport the first user to a location where the second user is assumed to be present.

Note that the route determination method for the route search unit 23 is not limited to the above-described example. For example, the route search unit 23 may search for a route by sequentially changing a schedule to be a route search target without calculating an estimated required time. That is, the route search unit 23 determines, as a destination, the first location corresponding to the first schedule, which is a schedule after the departure time and has the earliest time, among the schedules indicated by the schedule information, searches for a route, and when, as a result of searching for the route, there is a route for arriving at the destination within a time period during which the second user is to be present at the destination, determines this route as the route of the vehicle 1. When there is no route for arriving at the destination within the time period during which the second user is to be present at the destination, the route search unit 23 determines, as the destination, the second location corresponding to the second schedule, which is a schedule after the departure time and has the second earliest time, among the schedules indicated by the schedule information, searches for a route, and when, as a result of searching for the route, there is a route for arriving at the destination within the time period during which the second user is to be present at the destination, determines this route as the route of the vehicle 1. The route search unit 23 repeats these processes until the route for arriving at the destination in which the second user is to be present at the destination is found. In this case, since the route search unit 23 searches for the destination together with the route, the route search unit 23 also has a function as the destination setting unit 22. The route determination method for the route search unit 23 is not limited to these examples.

Note that, as the departure location, for example, the current position of the vehicle 1 indicated by position information (to be described later) received by the route search unit 23 from the self-position identifying unit 5 is set, but the present disclosure is not limited thereto. For example, the departure location may be designated by the vehicle dispatch management apparatus, or may be accepted as input by the acceptance unit (not illustrated).

The self-position identifying unit 5 identifies the self-position of the vehicle 1, and outputs position information indicating the identified self-position to the travel control unit 3 and the route search unit 23. For example, the self-position identifying unit 5 identifies the self-position by performing position determination using a satellite positioning system such as a Global Positioning System (GPS) or a Global Navigation Satellite System (GNSS). However, the self-position identification method for the self-position identifying unit 5 is not limited thereto. Note that, in a case where the position information is not used in the route search unit 23, the position information need not be output from the self-position identifying unit 5 to the route search unit 23.

The travel control unit 3 controls automated driving travel of the vehicle 1 by controlling the traveling mechanism 4 based on the route provided as a notification from the route search unit 23. For example, the travel control unit 3 controls the traveling mechanism 4 based on information acquired by a sensor (not illustrated) such as a camera, a Light Detection And Ranging (LiDAR), or a millimeter-wave sensor that detects an obstacle; the position information received from the self-position identifying unit 5; and the map information stored in the information storage unit 24. Note that the automated driving travel control for the vehicle 1 is not limited to any particular method as long as the control is performed in such a manner that the vehicle 1 travels on the route provided as a notification from the route search unit 23, and may be performed in any manner. Accordingly, a typical method can be employed, and thus a detailed description thereof will be omitted.

Furthermore, automated-driving map information, which is map information used by the travel control unit 3, may be different from the map information stored in the information storage unit 24. In this case, the travel control unit 3 controls travel of the vehicle 1 based on the automated-driving map information stored in a map information storage unit (not illustrated) within the vehicle 1. For example, the map information stored in the information storage unit 24 may be two-dimensional map information, and the automated-driving map information may be a dynamic map. In a case where the dynamic map is used as the automated-driving map information, information to be updated may be acquired by the information acquisition unit 21 or may be acquired by a transceiver unit (not illustrated).

The traveling mechanism 4 is a mechanism for causing the vehicle 1 to travel, and includes, for example, a plurality of mechanisms for causing the vehicle 1 to travel, such as an accelerator operation device such as an accelerator pedal, a steering device, and a brake.

In the present embodiment, since the route search unit 23 sets the destination of the vehicle 1 based on the schedule information on the second user different from the first user who rides in the vehicle 1, the route of the vehicle 1 can be determined without requiring the input of the destination by the first user who rides in the vehicle 1. For example, in a case where the first user who rides in the vehicle 1 is a child and the second user is a guardian of the child, the child who rides in the vehicle 1 can be transported to the guardian without requiring the input of the destination by the child.

Note that the information processing unit 2 may not only set the destination of the vehicle 1 based on the schedule information on the second user, but also, when the acceptance unit (not illustrated) accepts input of the destination, notify the route search unit 23 of the destination accepted by the acceptance unit, and the route search unit 23 may determine a route to the destination provided as a notification from the acceptance unit. Additionally, the information processing unit 2 may be capable of setting which of the determination of the destination of the vehicle 1 based on the schedule information on the second user, and the destination accepted by the acceptance unit is to be given priority. For example, at the time of the reservation of the vehicle 1, the user terminal of the second user accepts, from the second user, input of priority information indicating which of the two is to be given priority, and the user terminal transmits the priority information to the vehicle dispatch management apparatus. Then, the vehicle dispatch management apparatus transmits the priority information to the vehicle 1, the information acquisition unit 21 receives the priority information from the vehicle dispatch management apparatus and outputs the priority information to the route search unit 23, and the route search unit 23 determines a destination based on the priority information. For example, when the second user (guardian) inputs priority information indicating that priority is given to the determination of the destination of the vehicle 1 based on the schedule information on the second user, it is possible to prevent the first user (child) from inputting a destination not intended by the second user and being transported to that destination.

In the above-described example, the route search unit 23 notifies the travel control unit 3 of the determined route, but the present disclosure is not limited thereto. The route search unit 23 may store route information indicating the determined route in the information storage unit 24 or in a route information storage unit (not illustrated) within the vehicle 1. In this case, the travel control unit 3 controls travel of the vehicle 1 with reference to the route information stored in the information storage unit 24 or the route information storage unit.

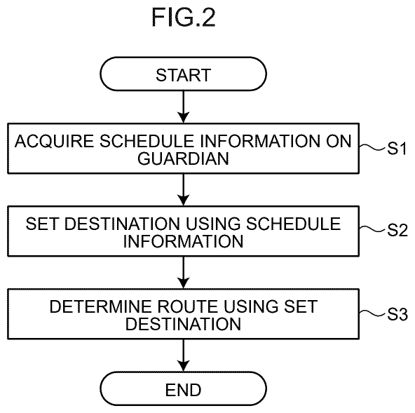

Next, a route determination method for the information processing unit 2 according to the present embodiment will be described. FIG. 2 is a flowchart illustrating an example of route determination processing for the information processing unit 2 according to the present embodiment. Note that, in an example illustrated in FIG. 2, the first user is a child and the second user is a guardian of the first user, but the first user and the second user are not limited to this example. Even in a case where the second user is a person other than the guardian, similar processing is performed.

As illustrated in FIG. 2, the information processing unit 2 acquires schedule information on the guardian (step S1). Specifically, the information acquisition unit 21 acquires, from the information providing apparatus 6, the schedule information on the guardian who is the second user, and stores the acquired schedule information in the information storage unit 24.

The information processing unit 2 sets a destination using the schedule information (step S2). For example, the destination setting unit 22 selects, as a route search target, from among schedules indicated by the schedule information stored in the information storage unit 24, a schedule in which the guardian is to be present at a location corresponding to the schedule at a time after elapse of an estimated required time from a scheduled departure time that is later than a departure time, sets, as a destination, the location corresponding to the schedule having been selected as the route search target, and notifies the route search unit 23 of the set destination.

Next, the information processing unit 2 determines a route using the set destination (step S3), and ends the route determination processing. Specifically, in step S3, the route search unit 23 searches for, using the map information stored in the information storage unit 24, a route (a route from the departure location to the destination) for arriving at the destination within a time period during which the guardian is to be present at the destination provided as a notification from the destination setting unit 22, and determines, as the route of the vehicle 1, the route obtained as a result of the search. For example, the route search unit 23 may search for a route by the Dijkstra method, the Bellman-Ford method, or the like for searching for a route that minimizes the cost by setting costs to edges connecting nodes, with intersections regarded as the nodes, may search for a route candidate by an exhaustive search method, may search for a route by a metaheuristic method, or may search for a route by a method other than these methods. For example, as the cost for the Dijkstra method, a distance or a required time can be used, but the cost is not limited thereto. Note that the departure location may be the current position of the vehicle 1 as described above, but the departure location is not limited thereto. For example, the departure location may be designated by the vehicle dispatch management apparatus, or may be accepted as input by the acceptance unit.

Note that, as a result of the route search in step S3, when there is no route for arriving at the destination within a time period during which the guardian is to be present at the destination, the route search unit 23 notifies the destination setting unit 22 of the fact, the destination setting unit 22 changes the schedule for the route search target and determines, as the destination, a location corresponding to a changed schedule, and the route search unit 23 searches for a route again. Note that, when a schedule for a route search target cannot be determined in step S2, or when no route for arriving at a destination within a time period during which the guardian is to be present at the destination is found in step S3, the destination setting unit 22 may determine, as the destination, a designated destination designated by the guardian. The designated destination may be set in advance by, for example, the guardian who is the second user. Alternatively, the destination setting unit 22 may generate request information for requesting setting of a destination, and transmit the generated request information to the user terminal of the guardian via an information transmission unit (not illustrated), and the information acquisition unit 21 may receive information indicating the designated destination from the user terminal and store the received information in the information storage unit 24. The destination setting unit 22 can grasp the designated destination by reading the information indicating the designated destination from the information storage unit 24.

Additionally, the information transmission unit (not illustrated) may transmit the set destination to the user terminal of the guardian. Consequently, the guardian can confirm the destination of the vehicle 1. Additionally, the information transmission unit may transmit the position information output from the self-position identifying unit 5 to the user terminal of the guardian. Consequently, the guardian can confirm the current position of the vehicle 1.

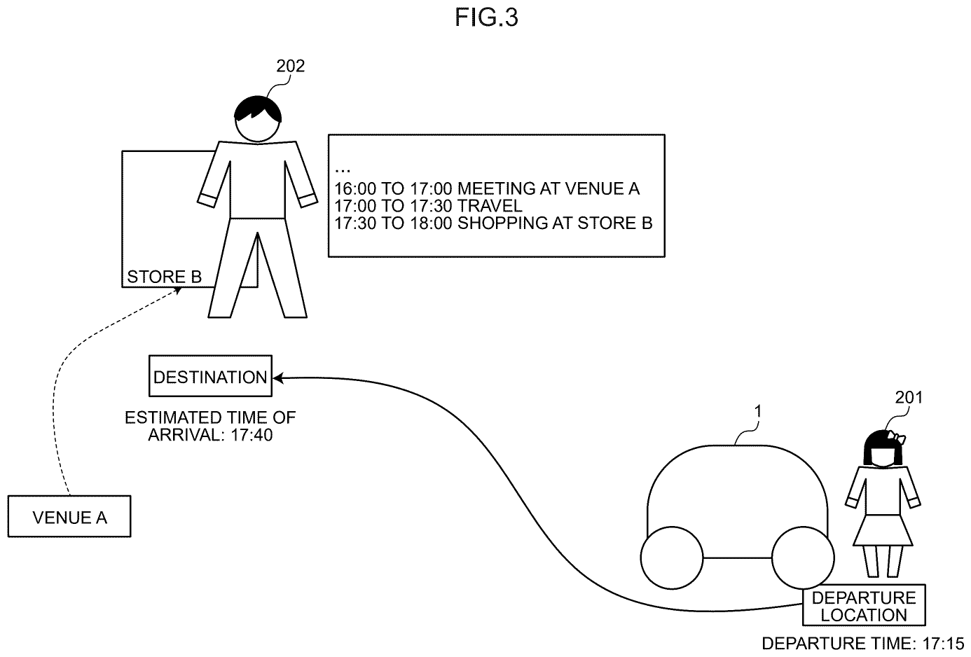

FIG. 3 is an image diagram illustrating a specific example of the route determination method according to the present embodiment. In the example illustrated in FIG. 3, herein, it is assumed that the number of stops is used, by way of example, as a route index. In the example illustrated in FIG. 3, a first user who is a child 201 is about to ride in the vehicle 1 at a departure location, the current time of the vehicle 1 is 17:15, and the departure time is assumed to be 17:15 on the assumption that the vehicle 1 departs immediately upon the riding of the child 201 in the vehicle 1. The rectangular frame in the upper part of FIG. 3 indicates an example of the time schedule of a mother 202 of the child 201, and the mother 202 is scheduled to attend a meeting at a venue A from 16:00 to 17:00 and is scheduled to shop at a store B from 17:30 to 18:00. The information processing unit 2 of the vehicle 1 performs the processing illustrated in FIG. 2, and is assumed to obtain, as a result of the search, a route for arriving at the store B at 17:40. Since the guardian is scheduled to be present at the store B from 17:30 to 18:00, when the vehicle 1 travels on this route, the vehicle 1 is assumed to arrive at the store B while the guardian is to be present at the store B.

Note that, depending on traffic conditions, if the arrival time would be delayed from the time predicted at the time when the route is determined, the destination and the route may be reset again by performing the processing illustrated in FIG. 2, using the vehicle's position at that time as the departure location.

Note that, in determining the route, the information processing unit 2 may set a route with as few stops as possible during travel to the destination, in order to prevent the first user from being involved in a crime. For example, the information acquisition unit 21 acquires traffic signal information indicating a timing of switching light colors of a traffic light (traffic signal), that is, a timing of switching lighting colors of the traffic light, and the traffic jam information indicating the occurrence situation of the traffic jam, from the information providing apparatus 6 that provides these pieces of information, and stores the acquired traffic signal information and traffic jam information in the information storage unit 24.

The traffic signal information may be, for example, information indicating a signal cycle, that is, the length of one cycle in which the signals are lit in order of green, yellow (or blinking of green), and red, lighting duration of respective lighting colors, and a reference time, or may be information indicating respective scheduled times themselves at which the signals are to change from green to yellow, from yellow to red, and from red to green. The reference time is, for example, a reference time for obtaining the time itself at which lighting of each color of the traffic light starts, and is, for example, the start time of any one cycle. When the start of one cycle corresponds to the start of lighting of the green signal, the lighting start time of the green signal in any cycle can be used as the reference time. In this case, the lighting start time of the green signal can be obtained by adding an integral multiple of the signal cycle to the reference time. The reference time is not limited to the foregoing and needs only to be set such that the time itself at which lighting of each color of the traffic light starts can be obtained. The reference time may be a past time or a future time.

The route search unit 23 sets, as a route candidate, the route determined in step S3, and performs determination processing of determining, based on the traffic signal information and the traffic jam information, whether at least one of a first stop and a second stop occurs in the route candidate. The first stop is a stop of the vehicle 1 due to the light color of the traffic light. The second stop is a stop of the vehicle 1 due to the traffic jam. When, as a result of the determination processing, neither the first stop nor the second stop occurs in the route candidate, the route search unit 23 determines the route candidate as the route of the vehicle 1. For example, the route search unit 23 may also determine the route of the vehicle 1 based on at least one of the stop duration and the number of stops of the vehicle 1 on the route of the vehicle 1 from among route candidates for which at least one of the first stop and the second stop is determined to occur as a result of the determination processing. Specifically, for example, the route search unit 23 may determine, as the route of the vehicle 1, a route candidate having the fewest number of stops, or may determine, as the route of the vehicle 1, a route candidate having the smallest maximum value of stop duration in the route candidates. The route determination method for the route search unit 23 is not limited thereto.

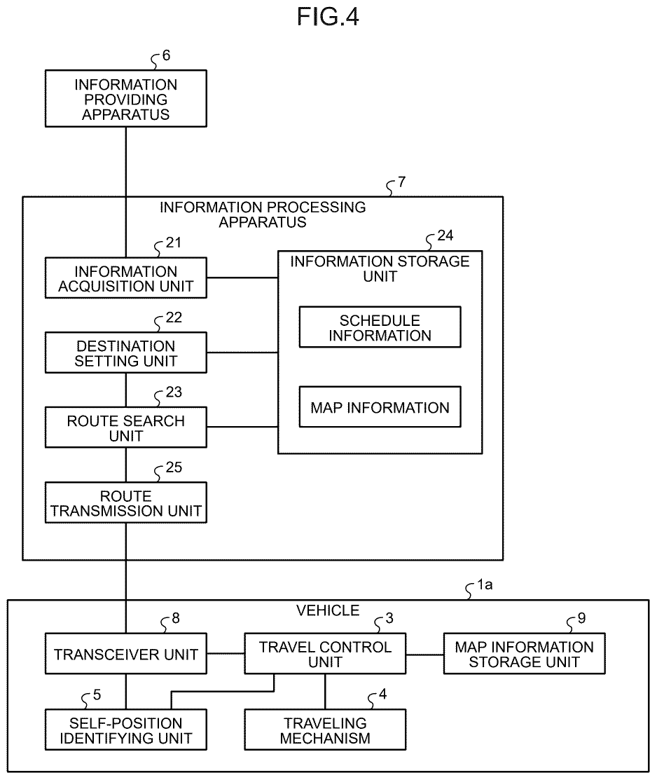

Note that, in the example illustrated in FIG. 1, the vehicle 1 performs the route determination processing according to the present embodiment, but the route determination processing may be performed by an apparatus different from the vehicle. FIG. 4 is a diagram illustrating an example of a route determination system according to the present embodiment. The route determination system according to the present embodiment includes a vehicle 1a and an information processing apparatus 7, and the route determination processing is performed by the information processing apparatus 7. Components having the similar functions to those in the example illustrated in FIG. 1 are denoted by the same reference numerals, and a redundant description will be omitted.

The information processing apparatus 7 illustrated in FIG. 4 includes a route transmission unit 25 in addition to the information processing unit 2 illustrated in FIG. 1. As compared to the vehicle 1 illustrated in FIG. 1, the vehicle 1a illustrated in FIG. 4 does not include the information processing unit 2 and includes a transceiver unit 8 and a map information storage unit 9. In the route determination system illustrated in FIG. 4, the self-position identifying unit 5 outputs position information indicating the position of the vehicle 1a to the travel control unit 3 and the transceiver unit 8. The transceiver unit 8 transmits the position information to the information processing apparatus 7. Note that, in a case where the route search unit 23 does not use the position information, the position information need not be output from the self-position identifying unit 5 to the transceiver unit 8.

The route search unit 23 of the information processing apparatus 7 illustrated in FIG. 4 performs the route determination processing in a similar manner to the route search unit 23 of the information processing unit 2 illustrated in FIG. 1, and outputs route information indicating the determined route to the route transmission unit 25. The route transmission unit 25 transmits the route information to the vehicle 1a

The transceiver unit 8 of the vehicle 1a receives the route information from the information processing apparatus 7 and outputs the received route information to the travel control unit 3. The travel control unit 3 controls travel of the vehicle 1a by controlling the traveling mechanism 4 based on the route indicated by the route information received from the transceiver unit 8. For example, as in the travel control unit 3 illustrated in FIG. 1, the travel control unit 3 controls the traveling mechanism 4 based on information acquired by a sensor (not illustrated), the position information, and the map information stored in the map information storage unit 9. The map information stored in the information storage unit 24 of the information processing apparatus 7 and the map information stored in the map information storage unit 9 may be the same or different from each other.

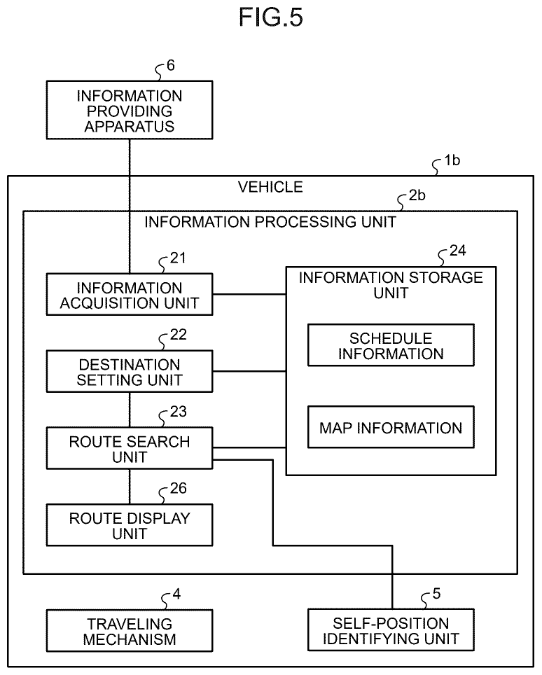

Note that the separation of the functions between the vehicle and the information processing apparatus is not limited to the example illustrated in FIG. 4. Additionally, in the examples illustrated in FIGS. 1 and 4, the vehicles 1 and 1a are automated driving vehicles, but the present embodiment can also be applied to a vehicle manually driven. FIG. 5 is a diagram illustrating an exemplary configuration of a manual driving vehicle according to the present embodiment. A vehicle 1b illustrated in FIG. 5 is a vehicle driven by a driver, that is, a manual driving vehicle. As illustrated in FIG. 5, as compared to the vehicle 1, the vehicle 1b does not include the travel control unit 3, and includes an information processing unit 2b instead of the information processing unit 2. Components having the similar functions to those in the example illustrated in FIG. 1 are denoted by the same reference numerals, and a redundant description will be omitted.

The information processing unit 2b is similar to the information processing unit 2 illustrated in FIG. 1 except that the information processing unit 2b includes a route display unit 26 in addition to the information processing unit 2 illustrated in FIG. 1. The route search unit 23 of the information processing unit 2b performs the route determination processing in a similar manner to the route search unit 23 of the information processing unit 2 illustrated in FIG. 1, and outputs route information indicating the determined route to the route display unit 26. The route display unit 26 displays the route indicated by the route information. The route display unit 26 may display the route on a map. In this case, the route search unit 23 may read the map information from the information storage unit 24 and pass the map information to the route display unit 26, or the route display unit 26 may read the map information from the information storage unit 24 and display the map information as a map.

Note that, even in a case where a manual driving vehicle is used, as in the example illustrated in FIG. 4, the information processing apparatus 7 may perform the route determination processing. In this case, the vehicle includes the route display unit 26 instead of the travel control unit 3 of the vehicle 1a illustrated in FIG. 4, the route information indicating the route determined by the information processing apparatus 7 is received by the transceiver unit 8, and the route indicated by the route information is displayed by the route display unit 26.

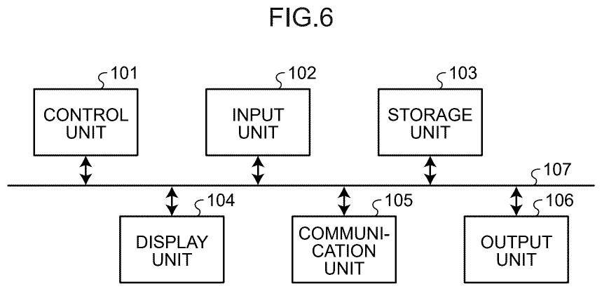

Next, hardware configurations of the information processing units 2 and 2b and the information processing apparatus 7 according to the present embodiment will be described. In each of the information processing units 2 and 2b and the information processing apparatus 7 according to the present embodiment, a program, which is a computer program describing processing for each of the information processing units 2 and 2b and the information processing apparatus 7, is executed on a computer system, so that the computer system serves as each of the information processing units 2 and 2b and the information processing apparatus 7. FIG. 6 is a diagram illustrating an exemplary configuration of a computer system that implements the information processing units 2 and 2b and the information processing apparatus 7 according to the present embodiment. As illustrated in FIG. 6, the computer system includes a control unit 101, an input unit 102, a storage unit 103, a display unit 104, a communication unit 105, and an output unit 106, which are connected through a system bus 107.

In FIG. 6, the control unit 101 is, for example, a processor such as a Central Processing Unit (CPU), and executes the program describing the processing for the information processing units 2 and 2b and the information processing apparatus 7 according to the present embodiment. The input unit 102 includes, for example, a keyboard, a button, a mouse, and the like, and is used by a user of the computer system to input various types of information. The storage unit 103 includes various memories such as a Random Access Memory (RAM) and a Read Only Memory (ROM) and a storage device such as a hard disk, and stores the program to be executed by the control unit 101, necessary data obtained in the course of processing, and the like. Additionally, the storage unit 103 is used as a temporary storage area for a program. The control unit 101 and the storage unit 103 constitute, for example, processing circuitry. The processing circuitry may be implemented as a single circuit or as a plurality of circuits. The display unit 104 includes a display, a Liquid Crystal Display (LCD), or the like, and displays various screens for a user of the computer system. Note that a touch panel in which the input unit 102 and the display unit 104 are integrated may be used. The communication unit 105 is a receiver and a transmitter that perform communication processing. The output unit 106 is a speaker or the like. Note that FIG. 6 is merely an example, and the configuration of the computer system is not limited to the example illustrated in FIG. 6. For example, the output unit 106 need not be provided.

Here, an exemplary operation of the computer system until the program according to the present embodiment becomes executable will be described. In the computer system having the above-described configuration, for example, a program is installed on the storage unit 103 from a Compact Disc (CD)-ROM or a Digital Versatile Disc (DVD)-ROM set in a CD-ROM drive or a DVD-ROM drive (not illustrated). Upon the execution of the program, the program read from the storage unit 103 is stored in the main storage area of the storage unit 103. In this state, the control unit 101 executes processing as each of the information processing units 2 and 2b and the information processing apparatus 7 according to the present embodiment in accordance with the program stored in the storage unit 103.

Note that, in the above description, the program describing the processing for each of the information processing units 2 and 2b and the information processing apparatus 7 is provided using the CD-ROM or the DVD-ROM as a recording medium, but the present disclosure is not limited thereto. A program may be used which is provided by, for example, a transmission medium such as the Internet via the communication unit 105 in accordance with the configuration of the computer system, the capacity of the provided program, and the like.

For example, the program according to the present embodiment causes the computer system to execute: a step of acquiring position-related information that is information related to a position of a second user different from a first user who rides in the vehicle 1; a step of setting a destination of the vehicle 1 using the position-related information; and a step of determining a route for the vehicle 1 to travel from a riding location where the first user rides in the vehicle 1 to the set destination.

The destination setting unit 22 and the route search unit 23 illustrated in FIGS. 1, 4, and 5 are implemented by the control unit 101 illustrated in FIG. 6 executing the program stored in the storage unit 103 illustrated in FIG. 6. The storage unit 103 is also used to implement the destination setting unit 22 and the route search unit 23 illustrated in FIGS. 1, 4, and 5. The information acquisition unit 21 illustrated in FIG. 1 is implemented by the communication unit 105 illustrated in FIG. 6. Some functions of the information acquisition unit 21 illustrated in FIG. 1 may be implemented by the control unit 101 and the storage unit 103. The information storage unit 24 is part of the storage unit 103. The acceptance unit (not illustrated) is implemented by at least one of the input unit 102 and the communication unit 105. The route display unit 26 illustrated in FIG. 5 is implemented by the display unit 104 illustrated in FIG. 6. The control unit 101 may be used to control the destination setting unit 22, the route display unit 26, and the information acquisition unit 21. The information processing units 2 and 2b and the information processing apparatus 7 may be implemented by a plurality of computer systems. Furthermore, for example, the information processing apparatus 7 may be implemented by a cloud computer system.

Each of the travel control unit 3 illustrated in FIG. 1, and the travel control unit 3 and the map information storage unit 9 illustrated in FIG. 4, is also implemented by a computer system. The travel control unit 3 illustrated in FIG. 1, and the travel control unit 3 and the map information storage unit 9 illustrated in FIG. 4 are implemented by, for example, processing circuitry including the control unit 101 and the storage unit 103 illustrated in FIG. 6. Additionally, the travel control unit 3 and the information processing unit 2 illustrated in FIG. 1 may be implemented by a single computer system. Additionally, in a case of acquiring the position information by GNSS positioning, the self-position identifying unit 5 illustrated in FIGS. 1, 4, and 5 includes a GNSS antenna, and the position information is calculated by the above-described control circuit using a signal received by the GNSS antenna.

As described above, in the present embodiment, since the information processing units 2 and 2b and the information processing apparatus 7 set the destination of the vehicle 1 based on the schedule information on the second user different from the first user who rides in the vehicle 1, it is possible to determine the route of the vehicle 1 without requiring the input of the destination by the first user who rides in the vehicle 1. For example, in the case where the first user who rides in the vehicle 1 is a child and the second user is a guardian of the child, the child who rides in the vehicle 1 can be transported to the guardian without requiring the input of the destination by the child.

### Second Embodiment

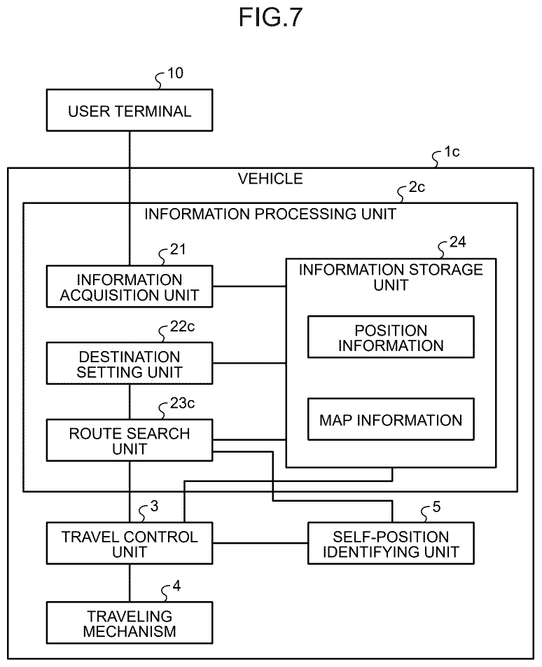

FIG. 7 is a diagram illustrating an exemplary configuration of a vehicle according to a second embodiment. A vehicle 1c according to the present embodiment is similar to the vehicle 1 according to the first embodiment except that the vehicle 1c includes an information processing unit 2c instead of the information processing unit 2. Components having the similar functions to those in the first embodiment are denoted by the same reference numerals as those in the first embodiment, and a redundant description will be omitted. Hereinafter, points different from the first embodiment will be mainly described.

In the first embodiment, the destination of the vehicle 1 is determined based on the schedule information on the second user different from the first user who rides in the vehicle 1, but in the present embodiment, the vehicle 1c determines the destination of the vehicle 1c based on the position of the second user.

As illustrated in FIG. 7, the information processing unit 2c is similar to the information processing unit 2 according to the first embodiment except that the information processing unit 2c includes a destination setting unit 22c and a route search unit 23c instead of the destination setting unit 22 and the route search unit 23. As in the first embodiment, the information acquisition unit 21 receives information by communicating with another apparatus. In the present embodiment, for example, the information acquisition unit 21 acquires, from a user terminal 10 carried by the second user, position information indicating the position (current position) of the user terminal 10, and stores the acquired position information in the information storage unit 24. The position information on the second user is an example of position-related information that is information related to the position of the second user. The information storage unit 24 is capable of storing various types of information and, in the present embodiment, for example, as illustrated in FIG. 7, stores position information and map information.

The destination setting unit 22c sets a destination of the vehicle 1 using the position information stored in the information storage unit 24, and notifies the route search unit 23c of the set destination. For example, the destination setting unit 22c sets, as the destination, the position of the second user indicated by the position information stored in the information storage unit 24. Note that, in FIG. 7, the position information acquired by the information acquisition unit 21 is stored in the information storage unit 24, but the present disclosure is not limited thereto. The position information acquired by the information acquisition unit 21 may be directly output from the information acquisition unit 21 to the destination setting unit 22c. The route search unit 23c searches for, using the map information stored in the information storage unit 24, a route of the vehicle 1c from the departure location to the destination provided as a notification from the destination setting unit 22c. As in the first embodiment, for example, the departure location may be the current position of the vehicle 1c, may be designated by the vehicle dispatch management apparatus, or may be accepted as input by the acceptance unit.

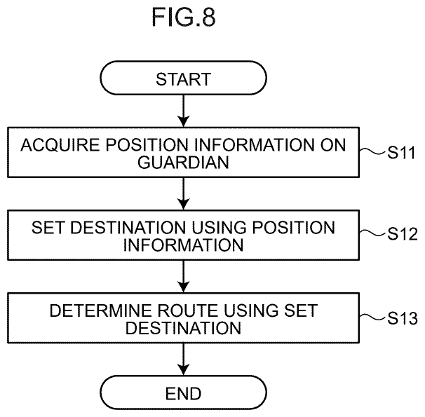

Next, a route determination method for the information processing unit 2c according to the present embodiment will be described. FIG. 8 is a flowchart illustrating an example of route determination processing for the information processing unit 2c according to the present embodiment. Note that, in an example illustrated in FIG. 8, the first user is a child and the second user is a guardian of the first user, but the first user and the second user are not limited to this example. Even in the case where the second user is a person other than the guardian, similar processing is performed.

As illustrated in FIG. 8, the information processing unit 2c acquires position information on the guardian (step S11). Specifically, the information acquisition unit 21 receives, from the user terminal 10 carried by the guardian, position information indicating the position of the user terminal 10 as position information indicating the position of the guardian, and stores the received position information in the information storage unit 24. The user terminal 10 is, for example, a smartphone, a tablet, a smart watch, a personal computer, or the like, but is not limited thereto, and may be any apparatus as long as it is capable of identifying a self-position and transmitting position information indicating the identified position. For example, the user terminal 10 may be an apparatus specialized for identifying and transmitting position information.

The information processing unit 2c sets a destination using the position information (step S12). For example, the destination setting unit 22c sets the destination by determining, as the destination, the position of the guardian indicated by the position information stored in the information storage unit 24, and notifies the route search unit 23c of the set destination.

Next, the information processing unit 2c determines a route using the set destination (step S13), and ends the route determination processing. Specifically, in step S13, the route search unit 23c searches for, using the map information stored in the information storage unit 24, the route of the vehicle 1c from the departure location to the destination, and determines, as the route of the vehicle 1c, the route obtained as a result of the search. For example, the route search unit 23c may search for a route by the Dijkstra method, the Bellman-Ford method, or the like, may search for a route candidate by an exhaustive search method, may search for a route by a metaheuristic method, or may search for a route by a method other than these methods. For example, as the cost for the Dijkstra method, a distance or a required time can be used, but the cost is not limited thereto.

As in the information processing units 2 and 2b according to the first embodiment, the information processing unit 2c illustrated in FIG. 7 is also implemented by a computer system. The destination setting unit 22c and the route search unit 23c illustrated in FIG. 7 are implemented by the control unit 101 illustrated in FIG. 6 executing the program stored in the storage unit 103 illustrated in FIG. 6. The storage unit 103 is also used to implement the destination setting unit 22c and the route search unit 23c illustrated in FIG. 7.

Note that, in the example illustrated in FIG. 7, as in the example illustrated in FIG. 1, the vehicle 1c performs the route determination processing, but the present disclosure is not limited thereto. As in the example illustrated in FIG. 4, the information processing apparatus may perform the route determination processing. In this case, for example, the information processing apparatus 7 illustrated in FIG. 4 includes the destination setting unit 22c and the route search unit 23c instead of the destination setting unit 22 and the route search unit 23 illustrated in FIG. 4, and the information acquisition unit 21 acquires the position information from the user terminal 10. Additionally, as in the first embodiment, the separation of the functions between the information processing apparatus and the vehicle is not limited to this example.

Additionally, in the example illustrated in FIG. 7, the vehicle 1c is an automated driving vehicle, but as in the example illustrated in FIG. 5, the configuration and operation according to the present embodiment can also be applied to a manual driving vehicle. In this case, for example, the information processing unit 2b illustrated in FIG. 5 includes the destination setting unit 22c and the route search unit 23c instead of the destination setting unit 22 and the route search unit 23 illustrated in FIG. 5, and the information acquisition unit 21 acquires the position information from the user terminal 10.

As described above, in the present embodiment, since the information processing unit 2c sets the destination of the vehicle 1c based on the position of the second user different from the first user who rides in the vehicle 1c, it is possible to determine the route of the vehicle 1c without requiring the input of the destination by the first user who rides in the vehicle 1c. For example, in the case where the first user who rides in the vehicle 1c is a child and the second user is a guardian of the child, the child who rides in the vehicle 1c can be transported to the guardian without requiring the input of the destination by the child.

### Third Embodiment

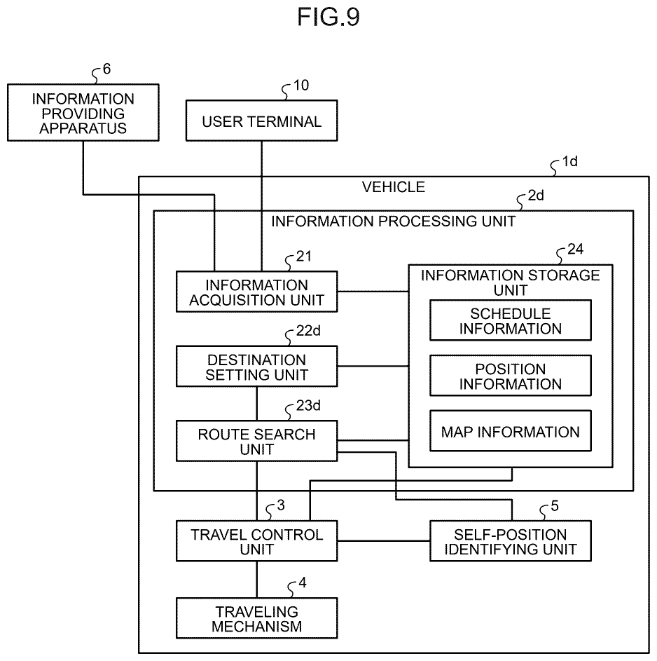

FIG. 9 is a diagram illustrating an exemplary configuration of a vehicle according to a third embodiment. A vehicle 1d according to the present embodiment is similar to the vehicle 1 according to the first embodiment except that the vehicle 1d includes an information processing unit 2d instead of the information processing unit 2. Components having the similar functions to those in the first and second embodiments are denoted by the same reference numerals as those in the first and second embodiments, and a redundant description will be omitted. Hereinafter, points different from the first and second embodiments will be mainly described.

In the first embodiment, the destination of the vehicle 1 is determined based on the schedule information on the second user different from the first user who rides in the vehicle 1, and in the second embodiment, the destination of the vehicle 1c is determined based on the position information on the second user. In the present embodiment, a description will be given of an example of switching between the determination of the destination of the vehicle 1d based on the schedule information on the second user and the determination of the destination of the vehicle 1d based on the position information on the second user.

As illustrated in FIG. 9, the information processing unit 2d is similar to the information processing unit 2 according to the first embodiment except that the information processing unit 2d includes a destination setting unit 22d and a route search unit 23d instead of the destination setting unit 22 and the route search unit 23. As in the first embodiment, the information acquisition unit 21 receives information by communicating with another apparatus. In the present embodiment, the information acquisition unit 21 acquires, from the information providing apparatus 6, the schedule information on the second user, and stores the schedule information in the information storage unit 24. In the present embodiment, the information acquisition unit 21 further acquires, from the user terminal 10 carried by the second user, position information indicating the position of the user terminal 10, and stores the acquired position information in the information storage unit 24. Note that, although FIG. 9 individually illustrates the information providing apparatus 6 and the user terminal 10, the information providing apparatus 6 may be the user terminal 10 as described in the first embodiment. That is, the information providing apparatus 6 and the user terminal 10 may be the same apparatus. The information storage unit 24 is capable of storing various types of information and, in the present embodiment, for example, as illustrated in FIG. 9, stores schedule information, position information, and map information.

The destination setting unit 22d is capable of performing both the determination of the destination of the vehicle 1d based on the schedule information on the second user and the determination of the destination of the vehicle 1d based on the position information on the second user. For example, at the time of departure of the vehicle 1d, the destination setting unit 22d sets a destination by determining the destination of the vehicle 1d based on the schedule information on the second user, and notifies the route search unit 23d of the set destination, and, when a destination review condition that is a predetermined condition is satisfied, resets the destination by determining the destination of the vehicle 1d based on the position information on the second user, and notifies the route search unit 23d of the reset destination. That is, for example, the destination setting unit 22d determines the destination using the schedule information, and then, when a predetermined condition is satisfied, resets the destination of the vehicle 1d using the position information, and the route search unit 23d may determine a route for the vehicle 1d to travel from the current position of the vehicle 1d to the destination that has been reset by the destination setting unit 22d. Note that, in the present embodiment, the self-position identifying unit 5 also outputs position information indicating the current position of the vehicle 1d to the destination setting unit 22d.

Examples of the destination review condition include, but are not limited to, a condition that a distance from the currently set destination is less than or equal to a threshold, a condition that an estimated required time to the currently set destination is less than or equal to a threshold, a condition that the elapsed time from departure is greater than or equal to a threshold, and a condition that a distance between the position of the second user estimated based on the schedule information and the current position of the second user indicated by the position information is greater than or equal to a threshold. For example, when the distance between the currently set destination and the vehicle 1d is less than or equal to the threshold, the vehicle 1d can adjust the destination in accordance with the actual position of the second user by resetting the destination of the vehicle 1d based on the position information on the second user. Furthermore, when the distance between the position of the second user estimated based on the schedule information and the current position of the second user indicated by the position information is greater than or equal to the threshold, the destination of the vehicle 1d is reset based on the position information on the second user. Thus, when the actual action of the second user is changed from the schedule, the destination can be reset in accordance with the actual position.

Note that the switching of the destination determination method for the destination setting unit 22d is not limited to this example. For example, at the time of departure of the vehicle 1d, the destination setting unit 22d may set a destination by determining the destination of the vehicle 1d based on the position information on the second user, and notify the route search unit 23d of the set destination, and, when the destination review condition is satisfied, may reset a destination by determining the destination of the vehicle 1d based on the schedule information on the second user, and notify the route search unit 23d of the reset destination. The destination review condition in this case is, for example, a condition that the position information on the second user cannot be received for a certain period of time or more, but is not limited thereto.

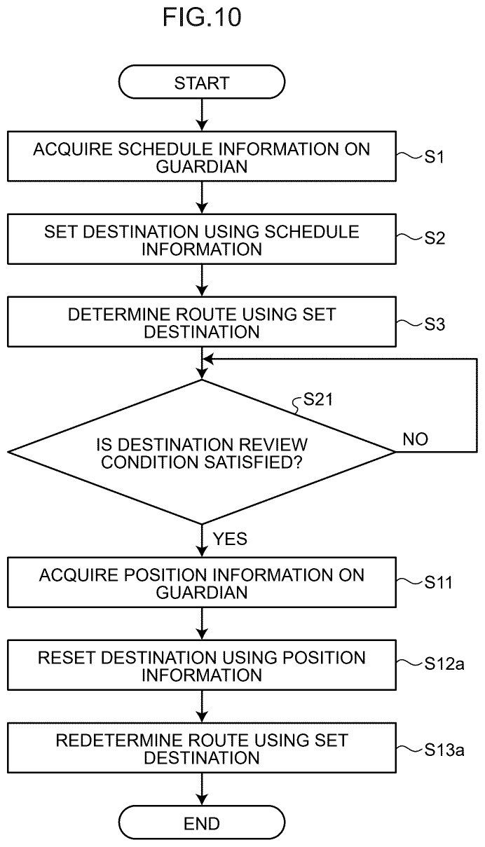

Next, a route determination method for the information processing unit 2d according to the present embodiment will be described. FIG. 10 is a flowchart illustrating an example of route determination processing for the information processing unit 2d according to the present embodiment. Note that, in an example illustrated in FIG. 10, the first user is a child and the second user is a guardian of the first user, but the first user and the second user are not limited to this example. Even in the case where the second user is a person other than the guardian, similar processing is performed.

As illustrated in FIG. 10, the information processing unit 2d performs steps S1 to S3 as in the first embodiment. The information processing unit 2d determines whether the destination review condition is satisfied (step S21). Specifically, the destination setting unit 22d determines whether the destination review condition is satisfied.

When the destination review condition is not satisfied (No in step S21), step S21 is repeated. When the destination review condition is satisfied (Yes in step S21), step S11 is performed as in the second embodiment. The information processing unit 2d resets the destination using the position information (step S12a). For example, the destination setting unit 22d resets the destination by determining, as the destination, the position of the guardian indicated by the position information stored in the information storage unit 24, and notifies the route search unit 23d of the set destination.

Next, the information processing unit 2d redetermines a route using the set destination (step S13a), and ends the route determination processing. In step S13a, the route search unit 23d searches for, using the map information stored in the information storage unit 24, the route of the vehicle 1d from the current position of the vehicle 1d indicated by the position information output from the self-position identifying unit 5 to the reset destination, and resets the route by determining, as the route of the vehicle 1d, the route obtained as a result of the search.

Note that the example illustrated in FIG. 10 is merely an example, and the present disclosure is not limited thereto. As described above, the determination of the destination of the vehicle 1d is performed based on the position information on the second user, and then, when the destination review condition is satisfied, the redetermination of the destination of the vehicle 1d based on the schedule information on the second user may be performed. Additionally, the redetermination of the route illustrated in FIG. 10 is performed, and then, when the destination review condition (switching condition for switching from the determination of the destination of the vehicle 1d based on the position information on the second user to the determination of the destination of the vehicle 1d based on the schedule information on the second user) is further satisfied, the redetermination of the destination of the vehicle 1d based on the schedule information on the second user is performed; that is, switching of the destination determination method may be performed multiple times.

As in the information processing units 2 and 2b according to the first embodiment and the information processing unit 2c according to the second embodiment, the information processing unit 2d illustrated in FIG. 10 is also implemented by a computer system. The destination setting unit 22d and the route search unit 23d illustrated in FIG. 9 are implemented by the control unit 101 illustrated in FIG. 6 executing the program stored in the storage unit 103 illustrated in FIG. 6. The storage unit 103 is also used to implement the destination setting unit 22d and the route search unit 23d illustrated in FIG. 10.

Note that, in the example illustrated in FIG. 9, as in the example illustrated in FIG. 1, the vehicle 1d performs the route determination processing, but the present disclosure is not limited thereto. As in the example illustrated in FIG. 4, the information processing apparatus may perform the route determination processing. In this case, for example, the information processing apparatus 7 includes the destination setting unit 22d and the route search unit 23d instead of the destination setting unit 22 and the route search unit 23 illustrated in FIG. 4, and the information acquisition unit 21 acquires the schedule information from the information providing apparatus 6 and acquires the position information from the user terminal 10. Additionally, as in the first embodiment, the separation of the functions between the information processing apparatus and the vehicle is not limited to this example.

Additionally, in the example illustrated in FIG. 10, the vehicle 1d is an automated driving vehicle, but as in the example illustrated in FIG. 5, the configuration and operation according to the present embodiment can also be applied to a manual driving vehicle. In this case, for example, the information processing unit 2b illustrated in FIG. 5 includes the destination setting unit 22d and the route search unit 23d instead of the destination setting unit 22 and the route search unit 23 illustrated in FIG. 5, and the information acquisition unit 21 acquires the schedule information from the information providing apparatus 6 and acquires the position information from the user terminal 10.

As described above, in the present embodiment, the information processing unit 2d switches between the determination of the destination of the vehicle 1d based on the schedule information on the second user and the determination of the destination of the vehicle 1d based on the position information on the second user. Consequently, the similar effects to those of the first embodiment can be obtained, and the destination can be set more appropriately in accordance with the situation. For example, in the case where the first user who rides in the vehicle 1d is a child and the second user is a guardian of the child, after the vehicle 1d has departed with a destination set based on schedule information on the guardian, when the distance between the currently set destination and the vehicle 1d is less than or equal to a threshold, the destination can be adjusted, by switching the destination determination method, in accordance with the actual position of the guardian.

The information processing apparatus according to the present disclosure has an effect of being able to determine a route for a vehicle to travel without requiring input of a destination by a user who rides in the vehicle.

The features illustrated in connection with the above embodiments are illustrative only and may be combined with the other known techniques. The embodiments may be combined with each other. The features may partially be omitted or modified without departing from the gist.

What is claimed is:

1. An information processing apparatus to determine a route for a vehicle to travel, the information processing apparatus comprising:
information acquisition circuitry to acquire position-related information that is information related to a position of a second user different from a first user who rides in the vehicle;
destination setting circuitry to set a destination of the vehicle, using the position-related information; and
route search circuitry to determine a route for the vehicle to travel from a riding location where the first user rides in the vehicle to the destination set by the destination setting circuitry, wherein
the position-related information is schedule information indicating a schedule of the second user,
the schedule indicated by the schedule information indicates a correspondence between a location where the second user is to be present and a time period during which the second user is to be present at the location, and
the destination is a location corresponding to the schedule that allows the vehicle to arrive thereat during presence of the second user at the location corresponding to the schedule.

2. The information processing apparatus according to claim 1, wherein
the schedule information is managed by a schedule information management system different from a mobility service system to provide a vehicle mobility service, and
the information acquisition circuitry acquires the schedule information from the schedule information management system.

3. The information processing apparatus according to claim 1, wherein
when the first user rides in the vehicle, the first user presents presentation information, the presentation information being reservation identification information, user identification information on the first user, or user identification information on the second user, the reservation identification information being assigned to reservation of the vehicle, and
the information acquisition circuitry acquires the schedule information, using the presentation information.

4. An information processing apparatus to determine a route for a vehicle to travel, the information processing apparatus comprising:
information acquisition circuitry to acquire position-related information that is information related to a position of a second user different from a first user who rides in the vehicle;
destination setting circuitry to set a destination of the vehicle, using the position-related information; and
route search circuitry to determine a route for the vehicle to travel from a riding location where the first user rides in the vehicle to the destination set by the destination setting circuitry, wherein
the position-related information is position information indicating a result of detecting the position of the second user,
the destination setting circuitry determines the destination, using schedule information indicating a schedule of the second user as the position-related information, and then, when a predetermined condition is satisfied, resets the destination of the vehicle, using the position information, and
the route search circuitry determines a route for the vehicle to travel from a current position of the vehicle to the destination reset by the destination setting circuitry.

5. The information processing apparatus according to claim 4, wherein the first user is a child, and the second user is a guardian of the first user.

6. The information processing apparatus according to claim 4, wherein the predetermined condition is a condition that a distance from the destination that is being set for the vehicle is less than or equal to a threshold.

7. A vehicle comprising:
information acquisition circuitry to acquire position-related information that is information related to a position of a second user different from a first user who rides in the vehicle;
destination setting circuitry to set a destination of the vehicle, using the position-related information; and
route search circuitry to determine a route for the vehicle to travel from a riding location where the first user rides in the vehicle to the destination set by the destination setting circuitry, wherein
the position-related information is schedule information indicating a schedule of the second user,
the schedule indicated by the schedule information indicates a correspondence between a location where the second user is to be present and a time period during which the second user is to be present at the location, and
the destination is a location corresponding to the schedule that allows the vehicle to arrive thereat during presence of the second user at the location corresponding to the schedule.

8. A route determination method for an information processing apparatus to determine a route for a vehicle to travel, the route determination method comprising:
acquiring position-related information that is information related to a position of a second user different from a first user who rides in the vehicle;
setting a destination of the vehicle, using the position-related information; and
determining a route for the vehicle to travel from a riding location where the first user rides in the vehicle to the set destination, wherein
the position-related information is schedule information indicating a schedule of the second user,
the schedule indicated by the schedule information indicates a correspondence between a location where the second user is to be present and a time period during which the second user is to be present at the location, and
the destination is a location corresponding to the schedule that allows the vehicle to arrive thereat during presence of the second user at the location corresponding to the schedule.

9. A non-transitory storage medium to store a program that when executed by a computer system to determine a route for a vehicle to travel causes the computer system to execute:
acquiring position-related information that is information related to a position of a second user different from a first user who rides in the vehicle;
setting a destination of the vehicle using the position-related information; and
determining a route for the vehicle to travel from a riding location where the first user rides in the vehicle to the set destination, wherein
the position-related information is schedule information indicating a schedule of the second user,
the schedule indicated by the schedule information indicates a correspondence between a location where the second user is to be present and a time period during which the second user is to be present at the location, and
the destination is a location corresponding to the schedule that allows the vehicle to arrive thereat during presence of the second user at the location corresponding to the schedule.
